(19) United States
(12) Patent Application Publication
(10) Pub. No.: US 2023/0413706 A1
(43) Pub. Date: Dec. 28, 2023

(54) AUTOMATIC WEED CONTROL

(71) Applicant: VIPCOM APS, Herning (DK)

(72) Inventor: Jimmy Damgaard, Herning (DK)

(21) Appl. No.: 18/252,986

(22) PCT Filed: Nov. 16, 2021
(86) PCT No.: PCT/EP2021/081808

§ 371 Date: May 15, 2023

(30) Foreign Application Priority Data
Nov. 19, 2020 (DK) PA 2020 01304

(51) Int. Cl. A01B 45/00; A01M 21/02; A01B 31/00

(52) U.S. Cl. CPC A01B 45/00; A01B 69/008; A01B 31/00; A01M 21/02

(57) ABSTRACT

An apparatus for automatic weed control of gravel areas is shown. The apparatus includes a mobile robot, and a tool unit. The tool unit includes a mounting bracket, a tool frame sled, and a pair of foldable and/or flexible connectors spanning between the mounting bracket and the tool frame sled.

### TECHNICAL FIELD OF THE INVENTION

The present invention relates to weed control of gravel areas, and more particularly to apparatuses for such use.

### BACKGROUND OF THE INVENTION

Gravel driveways and pathways are a lot cheaper than block paving, good for drainage, and look better than and more ecofriendly than imprinted concrete. However, gravel pathways and driveways that have light traffic or are neglected can quickly become overgrown with weeds and grass. The same issue is present for sports courts, such as tennis courts, Petanque courts, and the like. Weed killers, like glyphosate, may be used, but is not very ecofriendly. That leaves one to remove the weed by hand and to prevent the weed from emerging by disturbing weed seeds from germinating by raking the surface. However, this is hard work.

### DESCRIPTION OF THE INVENTION

It is an object of the present invention to overcome the above-mentioned problems. The present invention provides an apparatus for automatically raking the gravel pathways, driveways, game courts, sports courts, or the like.

A first aspect relates to an apparatus for automatic weed control of gravel areas, said apparatus comprising:
a mobile robot; and
a tool unit;
wherein said tool unit comprises:
i) a mounting bracket;
ii) a tool frame sled with a front end and a rear end; and
iii) a pair of foldable and/or flexible connectors spanning between said mounting bracket and said tool frame sled;
wherein said mounting bracket is adapted for releasably fastening of said tool unit to said mobile robot;
wherein each of said connectors are fastened to each side of the rear end of said tool frame sled.

A second aspect relates to a tool unit adapted for mounting to a mobile robot, said tool unit comprising:
i) a mounting bracket;
ii) a tool frame sled with a front end and a rear end; and
iii) a pair of foldable and/or flexible connectors spanning between said mounting bracket and said tool frame sled;
wherein said mounting bracket is adapted for releasably fastening of said tool unit to said mobile robot;
wherein each of said connectors are fastened to each side of the rear end of said tool frame sled.

In the present context, the term “foldable and/or flexible connector” is to be understood as an elongate, flexible interconnection between the mounting bracket and the tool frame sled, such as a chain, a rope, a mesh, pivotally connected segments, or a wire. The term “flexible” is used specifically to refer to materials that can be repeatedly bent or folded, so that these materials can withstand externally applied forces, such as when the mobile robot makes a turn. The flexible connector makes it easier for the entire apparatus to make a sharp turn.

In the context of the invention, the term “gravel” refers to particles of varying sizes and dimensions that can include stones, rubble, clays, artificial sands, natural sands, and mixtures thereof used in drive ways, paths, sports courts, game courts, and the like. Hence, the apparatus and tool unit of the present invention may also be used for weed control of sports courts with artificial grass, where e.g., sand, natural or artificial, is used as infill, or where dirt inevitable will accumulate.

Within the context of the present application, the term “mobile robot” refers to an automatic machine that can move in any given environment. Mobile robots have the capability to move around in their environment and are not fixed to one physical location.

In one or more embodiments, the mounting bracket is adapted for being height adjustable relative to said mobile robot. This configuration allows for individual adjustment of the tool unit relative to any type of mobile robot but may also be used to finetune the way the tool unit works the gravel area, e.g., how deep the tool unit penetrates the gravel area's surface.

In one or more embodiments, the tool frame sled is adapted for tool exchange. Thereby, different types of tools may be used for different types of gravel and/or weed.

In one or more embodiments, the tool frame sled comprises:
a front end configured as a first elongate member spanning from one side of the front end to the other; and
a rear end configured as a second elongate member spanning from one side of the rear end to the other;
wherein a space is formed between said front end and said rear end. This configuration allows the tool frame to be used as part of the tool that works the gravel area.

The ends of the first and second elongate members are preferably curved upwards relative to the ground, thereby allowing the tool frame sled to bounce off obstacles.

In one or more embodiments, a pair of tool mounting units are fastened to each side of said first and second elongate members;
wherein said pair of tool mounting units are adapted for releasably fastening of a tool adapted for raking a surface. Thereby, different types of tools may be used for different types of gravel and/or weed.

The tools may have different configurations dependent on their intended use. Some tools may be configured as on or more elongate members spanning from one side of the tool frame sled to the other. Obviously, when used alone, the elongate members are adapted for raking a surface. An elongate member may, however, alternatively be configured with a plurality, such as 10-50, vertical plates extending below said elongate member. The vertical plates may curve upwards relative to the ground, thereby allowing the tool frame sled to bounce off obstacles. Such a shape may e.g., be semi-circular. The vertical plates may also be mounted at an oblique angle relative to the longitudinal axis of the elongate member. If more elongate members are present, the vertical plates on a first elongate member are mounted at a first oblique angle relative to said first longitudinal axis of the elongate member, while the vertical plates on a second neighboring elongate member are mounted at a second oblique angle relative to said second longitudinal axis of the elongate member. Preferably said first and second oblique angles are equal, but where one has a positive angle of rotation, while the other has a negative angle of rotation. This configuration secures that the tool frame sled moves straight.

In one or more embodiments, each tool mounting unit is fastened to each connector. Preferably, the connector is a chain, or a rope, or a wire. The tool mounting unit may comprise a guide channel adapted for receiving the chain or wire. The guide channel may be formed in the front end (the end facing the mobile robot) of the tool mounting unit, while one end of the chain, or rope, or wire is fastened to the rear end of the tool mounting unit. Obviously, the other end of the chain or wire is fastened to the mounting bracket adapted for releasably fastening of the tool unit to the mobile robot. Alternatively, the middle part of the chain, or rope, or wire is fastened to the rear end of the tool mounting unit, while the end of the chain, or rope, or wire is looped back and fastened to the mounting bracket. Hence, in this embodiment, both ends of the chain, or rope, or wire is fastened to the mounting bracket.

In one or more embodiments, the first and second elongate members are adapted for raking a surface.

In one or more embodiments, the mobile robot comprises a traction drive system and a boundary coverage system including a vehicle control unit commanding said traction drive system to drive said mobile robot relative to a boundary wire. Numerous systems exist for robotic mowers that could easily be implemented for the use of the present invention. A suitable example is mentioned in EP2413214, hereby incorporated by reference.

The mobile robot may include means or an apparatus for estimating its position in space to continue motion with a purpose. The modern framework of mapping localization comprises a coordinate system with respect to which the localization is done and a pose, which is a combination of position and orientation. Localization can be done with respect to an absolute coordinate system (such as GPS coordinates) or a relative coordinate system (such as localization with respect to some known location and/or object). The coordinate system can be chosen arbitrarily if it is consistent and can be converted to some standard coordinate system (such as WGS84) if needed. Multiple sensor readings can contribute to pose calculation—it can be determined using GPS receivers, Lidar (light radar) sensors, cameras, odometers, gyroscopes, accelerometers, magnetometers, time of flight cameras and radar sensors. The localization can be done based on an existing map, or it can be done simultaneously with mapping. The latter is called SLAM (Simultaneous Localization and Mapping) and is the preferred approach when localization is performed while exploring previously unknown surroundings. If a map is already available, the task becomes easier. Localization outdoors can be done with the help of a positioning system such as GPS (Global Positioning System), GLONASS (Global Navigation Satellite System) or Galileo.

In one or more embodiments, the mobile robot comprises a traction drive system and a boundary coverage system including a vehicle control unit commanding said traction drive system to drive said mobile robot relative to received information comprising waypoints, satellite position signals, such as gps or the like, cameras, total stations, or the like.

In one or more embodiments, the pair of foldable and/or flexible connectors are each made from chain, rope, or wire, and wherein the tool mounting units each comprises a guide channel adapted for receiving its own chain, rope, or wire. Preferably, the guide channel is formed in the front end of the tool mounting unit, wherein one part of each chain, rope, or wire is fastened to the rear end of the tool mounting units, and wherein an end of each chain, rope, or wire is fastened to the mounting bracket. Even more preferably, the opposite end of each chain, rope, or wire is also fastened to the mounting bracket.

As used in the specification and the appended claims, the singular forms “a”, “an”, and “the” include plural referents unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

It should be noted that embodiments and features described in the context of one of the aspects of the present invention also apply to the other aspects of the invention.

### BRIEF DESCRIPTION OF THE FIGURES

FIG. 1 shows an apparatus according to various embodiments of the present invention, where different tools are displayed.

FIG. 2 shows a closeup view of a tool unit according to various embodiments of the present invention.

FIG. 3 shows an apparatus according to various embodiments of the present invention, where the mobile robot is shown changing direction, while the tool unit retains its position.

FIGS. 4-10 show apparatuses according to various embodiments of the present invention with different tools mounted in the tool frame sled. In particular:

FIG. 4 shows a tool with a single elongate member.

FIG. 5 shows a tool with two elongate members.

FIG. 6 shows a tool with a single elongate member with twenty vertical plates extending below the elongate member.

FIG. 7 shows a tool with two elongate members, each with thirteen vertical plates extending below the elongate member.

FIG. 8 is a close-up view of FIG. 7.

FIG. 9 shows a tool with a single elongate member.

FIG. 10 is a close-up view of FIG. 9.

### DETAILED DESCRIPTION OF THE INVENTION

The following description is to be seen as a non-limiting example of an apparatus according to various embodiments of the present invention.

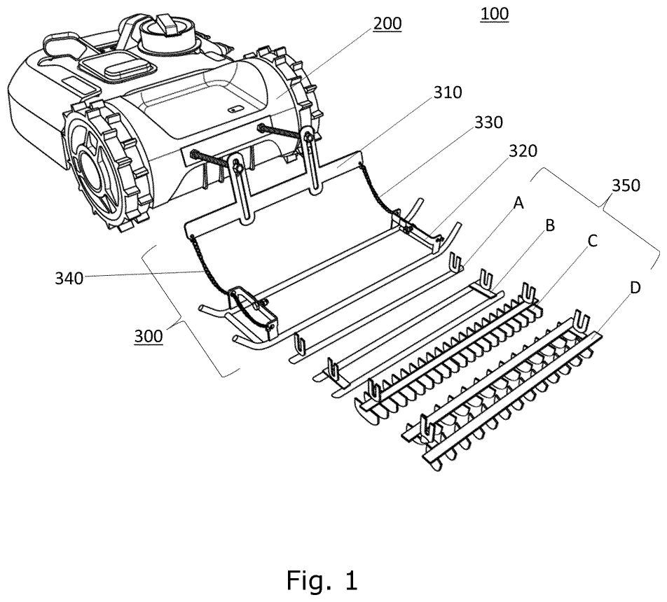

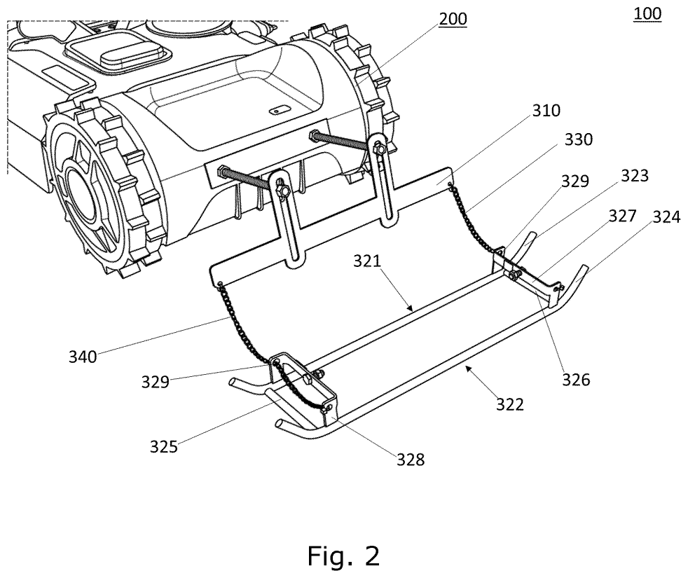

FIG. 1 shows an apparatus according to various embodiments of the present invention, where different tools 350A-D are displayed separately. The apparatus 100 comprises a mobile robot 200, and a tool unit 300. The tool unit 300 comprises a mounting bracket 310, a tool frame sled 320, and a pair of foldable and/or flexible connectors 330,340 (embodied as a chain) spanning between the mounting bracket 310 and the tool frame sled 320. FIG. 2 shows a closeup view of the tool unit 300. Here it can be seen that the tool frame sled 320 has a front end 321 and a rear end 322, and that each of said connectors 330,340 are fastened to each side of the rear end 322 of said tool frame sled 320. The front end 321 is configured as a first elongate member 323 spanning from one side of the front end to the other, and the rear end 322 is configured as a second elongate member 324 spanning from one side of the rear end to the other. A space is formed between the front end 321 and the rear end 322 by a spacer 325, 326 attached at each side. The space is adapted for receiving a tool 350A-D that is releasably fastened to the tool unit by a pair of tool mounting units 327, 328 fastened to each side of said first 323 and second 324 elongate members. The tool frame sled 320 comprises a guide channel 329 adapted for receiving a connector 330,340 (here embodied as a chain). The guide channel 329 is formed in the front end (the end facing the mobile robot) of the tool mounting units 327,328, while one end of the chains 330,340 are fastened to the rear end of the tool mounting units 327, 328. The other end of the chain is fastened to the mounting bracket 310. The mounting bracket 310 is adapted for being height adjustable relative to the mobile robot 200.

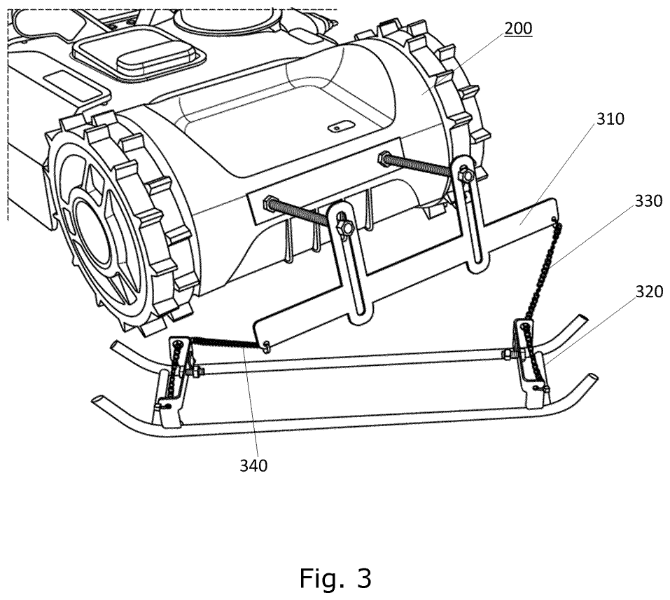

FIG. 3 shows an apparatus 100 where the mobile robot 200 is shown changing direction, while the tool frame sled 320 retains its position. That operation is possible due to the chains' 330,340 flexibility.

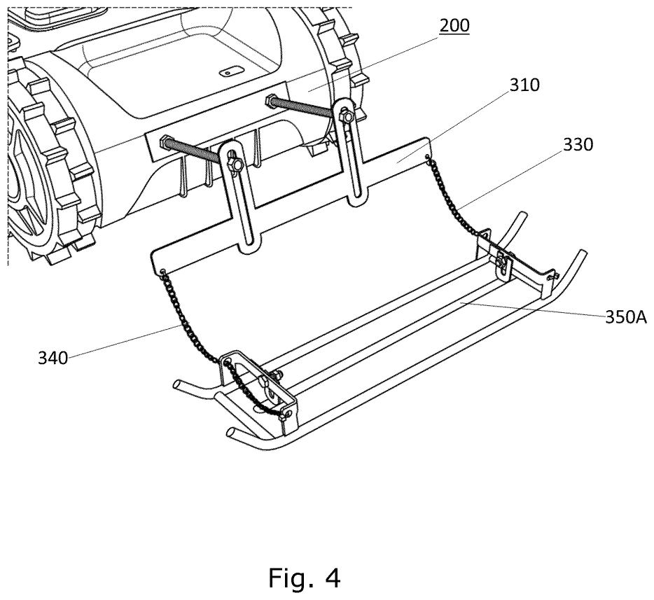

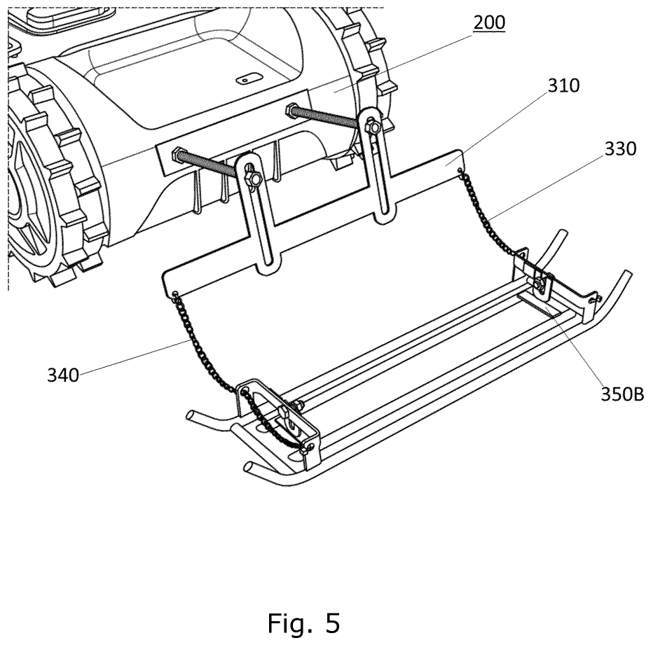

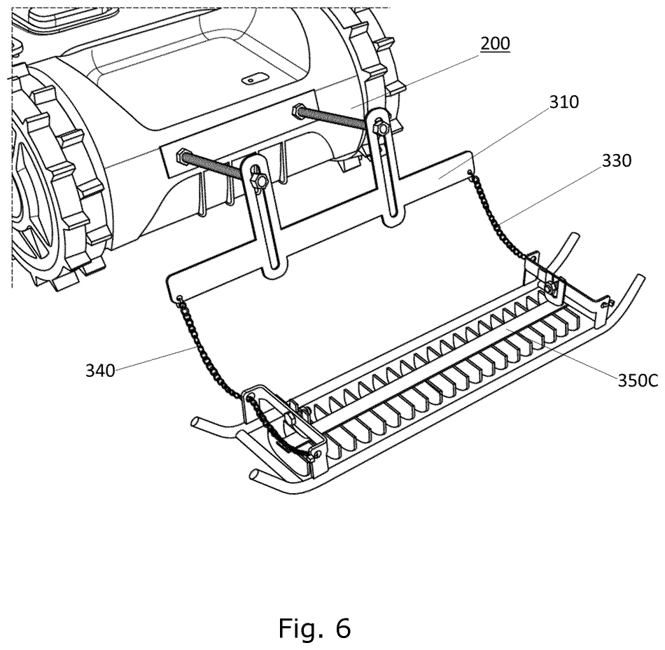

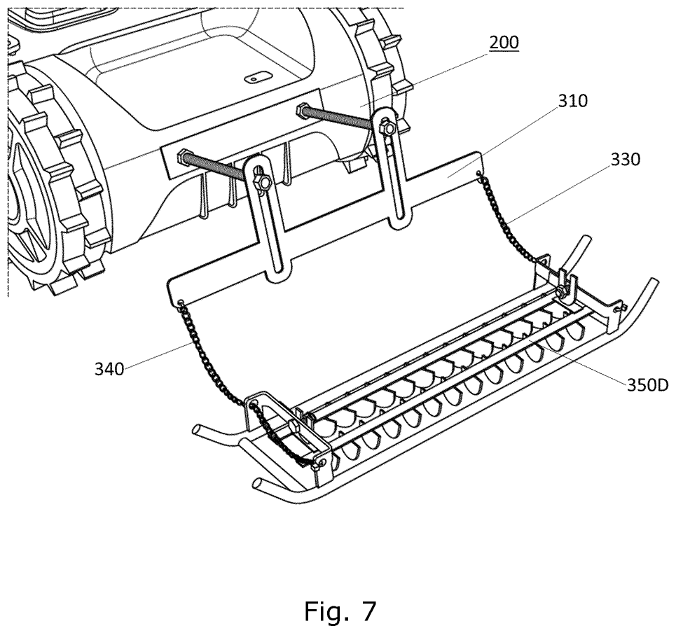

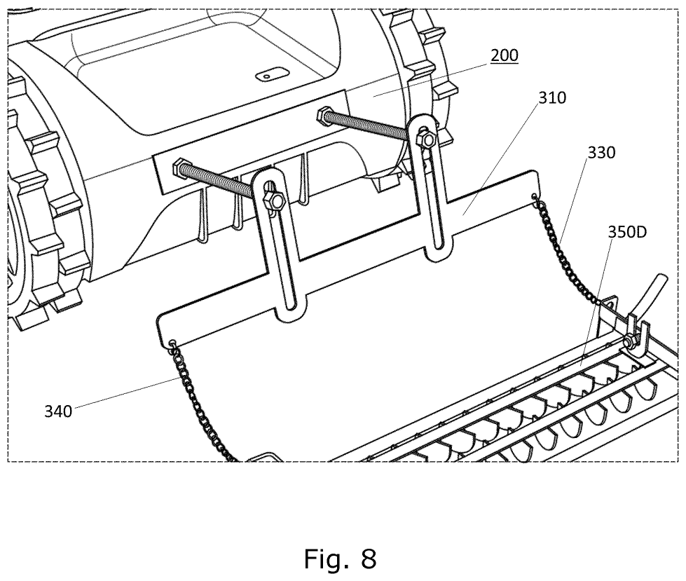

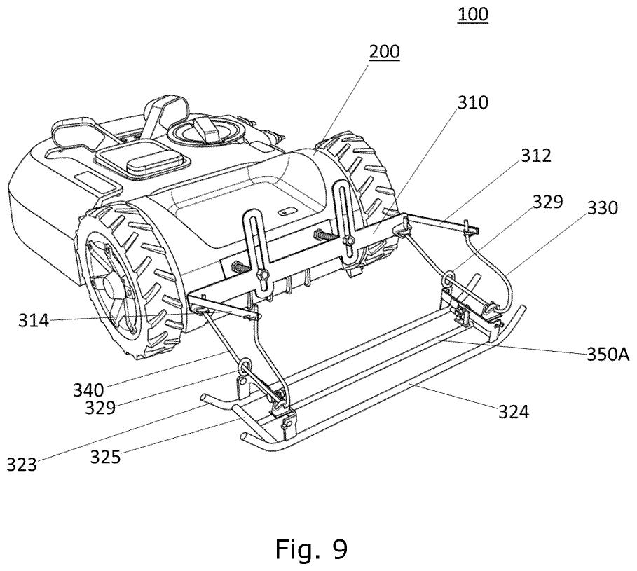

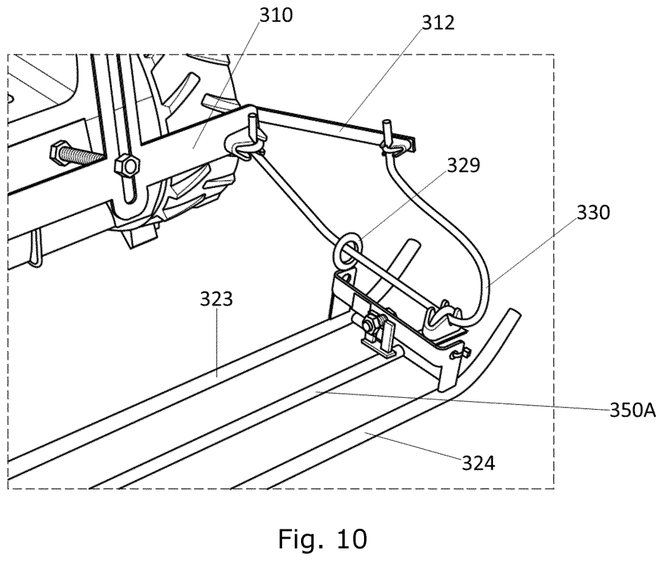

FIGS. 4-8 show apparatuses with different tools mounted in the tool frame sled. FIG. 4 shows a tool 350A with a single elongate member. FIG. 5 shows a tool 350B with two elongate members. FIG. 6 shows a tool 350C with a single elongate member with twenty vertical plates extending below the elongate member. The vertical plates curve upwards (a semi-circular shape) relative to the ground, thereby allowing the tool frame sled 320 to bounce off obstacles. FIG. 7 shows a tool 350D with two elongate members, each with thirteen vertical plates extending below the elongate member. The vertical plates on the first elongate member are mounted at a first oblique angle relative to said first longitudinal axis of the elongate member, while the vertical plates on the second neighboring elongate member are mounted at a second oblique angle relative to said second longitudinal axis of the elongate member. The first and second oblique angles may be equal, as shown, but where one has a positive angle of rotation, while the other has a negative angle of rotation. This configuration secures that the tool frame sled moves straight. FIG. 8 is a close-up view of FIG. 7. FIG. 9 shows a tool 350A with a single elongate member. The tool frame sled comprises a guide channel 329 adapted for receiving a connector 330,340 (here embodied as a rope). The guide channel 329 is formed in the front end (the end facing the mobile robot) of the tool mounting units 327,328. One end of the ropes is fastened to the mounting bracket 310, one part of the ropes 330,340 are fastened to the rear end of the tool mounting units 327, 328, and the other end of the ropes is also fastened to the mounting bracket 310. This embodiment ensures better maneuverability and control of the tool unit 300. The mounting bracket 310 is shown comprising a pair of protruding rods or plates 312, 314 to ensure an even better maneuverability and control of the tool unit 300. One of the ends of each rope is fastened to its own protruding rod or plate 312, 314. FIG. 10 is a close-up view of FIG. 9.

### REFERENCES

100 Apparatus for automatic weed control and leveling of gravel areas
200 Mobile robot
300 Tool unit
310 Mounting bracket
312 Protruding rod or plate
314 Protruding rod or plate
320 Tool frame sled
321 Front end
322 Rear end
323 First elongate member
324 Second elongate member
325 Spacer
326 Spacer
327 Tool mounting unit
328 Tool mounting unit
329 Guide channel
330 Connector
340 Connector
350 Tools

1.-21. (canceled)

22. An apparatus (100) for automatic weed control and/or leveling of gravel areas, said apparatus comprising:
a mobile robot (200); and
a tool unit (300);
wherein said tool unit (300) comprises:
i) a mounting bracket (310);
ii) a tool frame sled (320) with a front end (321) and a rear end (322); and
iii) a pair of flexible connectors (330,340) spanning between said mounting bracket (310) and said tool frame sled (320);
wherein said mounting bracket (310) is adapted for releasably fastening of said tool unit (300) to said mobile robot (200);
characterized in that each of said connectors (330,340) are fastened to each side of the rear end (322) of said tool frame sled (320).

23. The apparatus (100) according to claim 22, wherein said mounting bracket (310) is adapted for being height adjustable relative to said mobile robot (200).

24. The apparatus (100) according to claim 22, wherein said tool frame sled (320) is adapted for tool exchange.

25. The apparatus (100) according to claim 22, wherein said tool frame sled (320) comprises:
a front end configured as a first elongate member (323) spanning from one side of the front end (321) to the other; and
a rear end configured as a second elongate member (324) spanning from one side of the rear end (322) to the other;
wherein a space is formed between said front end (321) and said rear end (322).

26. The apparatus (100) according to claim 22, wherein said tool frame sled (320) comprises:
a front end configured as a first elongate member (323) spanning from one side of the front end (321) to the other; and
a rear end configured as a second elongate member (324) spanning from one side of the rear end (322) to the other;
wherein a space is formed between said front end (321) and said rear end (322); wherein a pair of tool mounting units (327, 328) are fastened to each side of said first (323) and second (324) elongate members;
wherein said pair of tool mounting units (327, 328) are adapted for releasably fastening of a tool (350) adapted for raking a surface.

27. The apparatus (100) according to claim 22, wherein said tool frame sled (320) comprises:
a front end configured as a first elongate member (323) spanning from one side of the front end (321) to the other; and
a rear end configured as a second elongate member (324) spanning from one side of the rear end (322) to the other;
wherein a space is formed between said front end (321) and said rear end (322); wherein said first (323) and second (324) elongate members are adapted for raking a surface.

28. The apparatus (100) according to claim 22, wherein said mobile robot (200) comprises a traction drive system and a boundary coverage system including a vehicle control unit commanding said traction drive system to drive said mobile robot (200) relative to a boundary wire.

29. The apparatus (100) according to claim 22, wherein the pair of flexible connectors (330,340) span between the mounting bracket (310) and the tool frame sled (320) two times.

30. The apparatus (100) according to claim 22, wherein the pair of flexible connectors (330,340) are each made from chain, rope, or wire, and wherein the tool mounting units (327, 328) each comprises a guide channel (329) adapted for receiving its own chain, rope, or wire.

31. The apparatus (100) according to claim 22, wherein the pair of flexible connectors (330,340) are each made from chain, rope, or wire, and wherein the tool mounting units (327, 328) each comprises a guide channel (329) adapted for receiving its own chain, rope, or wire; wherein the guide channel (329) is formed in the front end (321) of the tool mounting unit (327, 328), wherein one part of each chain, rope, or wire is fastened to the rear end (322) of the tool mounting units (327, 328), and wherein an end of each chain, rope, or wire is fastened to the mounting bracket (310).

32. The apparatus (100) according to claim 22, wherein the pair of flexible connectors (330,340) are each made from chain, rope, or wire, and wherein the tool mounting units (327, 328) each comprises a guide channel (329) adapted for receiving its own chain, rope, or wire; wherein the guide channel (329) is formed in the front end (321) of the tool mounting unit (327, 328), wherein one part of each chain, rope, or wire is fastened to the rear end (322) of the tool mounting units (327, 328), and wherein an end of each chain, rope, or wire is fastened to the mounting bracket (310); and wherein the opposite end of each chain, rope, or wire is also fastened to the mounting bracket (310).

33. The apparatus (100) according to claim 22, wherein the pair of flexible connectors (330,340) are each made from chain, rope, or wire, and wherein the tool mounting units (327, 328) each comprises a guide channel (329) adapted for receiving its own chain, rope, or wire; wherein the guide channel (329) is formed in the front end (321) of the tool mounting unit (327, 328), wherein one part of each chain, rope, or wire is fastened to the rear end (322) of the tool mounting units (327, 328), and wherein an end of each chain, rope, or wire is fastened to the mounting bracket (310); wherein the opposite end of each chain, rope, or wire is also fastened to the mounting bracket (310); and wherein the mounting bracket (310) comprises a pair of protruding rods or plates (312, 314), and wherein the opposite end of each chain, rope, or wire is fastened to its own protruding rod or plate (312, 314).

34. A tool unit (300) adapted for mounting to a mobile robot (200), said tool unit (300) comprising:
i) a mounting bracket (310);
ii) a tool frame sled (320) with a front end (321) and a rear end (322); and
iii) a pair of flexible connectors (330,340) spanning between said mounting bracket (310) and said tool frame sled (320);
wherein said mounting bracket (310) is adapted for releasably fastening of said tool unit (300) to said mobile robot (200);
characterized in that each of said connectors (330,340) are fastened to each side of the rear end (322) of said tool frame sled (320).

35. The tool unit (300) according to claim 34, wherein said tool frame sled (310) comprises:
a front end configured as a first elongate member (323) spanning from one side of the front end (321) to the other; and
a rear end configured as a second elongate member (324) spanning from one side of the rear end (322) to the other;
wherein a space is formed between said front end (321) and said rear end (322).

36. The tool unit (300) according to claim 34, wherein said tool frame sled (310) comprises:
a front end configured as a first elongate member (323) spanning from one side of the front end (321) to the other; and
a rear end configured as a second elongate member (324) spanning from one side of the rear end (322) to the other;
wherein a space is formed between said front end (321) and said rear end (322); and wherein a pair of tool mounting units (327, 328) are fastened to each side of said first (323) and second (324) elongate members;
wherein said pair of tool mounting units (327, 328) are adapted for releasably fastening of a tool (350) adapted for raking a surface.

37. The tool unit (300) according to claim 34, wherein said tool frame sled (310) comprises:
a front end configured as a first elongate member (323) spanning from one side of the front end (321) to the other; and
a rear end configured as a second elongate member (324) spanning from one side of the rear end (322) to the other;
wherein a space is formed between said front end (321) and said rear end (322); and wherein said first (323) and second (324) elongate members are adapted for raking a surface.

38. The tool unit (300) according to claim 34, wherein the pair of foldable and/or flexible connectors (330,340) span between the mounting bracket (310) and the tool frame sled (320) two times.

39. The tool unit (300) according to claim 34, wherein the pair of foldable and/or flexible connectors (330,340) are each made from chain, rope, or wire, and wherein the tool mounting units (327, 328) each comprises a guide channel (329) adapted for receiving its own chain, rope, or wire.

40. The tool unit (300) according to claim 34, wherein the pair of foldable and/or flexible connectors (330,340) are each made from chain, rope, or wire, and wherein the tool mounting units (327, 328) each comprises a guide channel (329) adapted for receiving its own chain, rope, or wire; wherein the guide channel (329) is formed in the front end (321) of the tool mounting unit (327, 328), wherein one part of each chain, rope, or wire is fastened to the rear end (322) of the tool mounting units (327, 328), and wherein an end of each chain, rope, or wire is fastened to the mounting bracket (310).

41. The tool unit (300) according to claim 34, wherein the pair of foldable and/or flexible connectors (330,340) are each made from chain, rope, or wire, and wherein the tool mounting units (327, 328) each comprises a guide channel (329) adapted for receiving its own chain, rope, or wire; wherein the guide channel (329) is formed in the front end (321) of the tool mounting unit (327, 328), wherein one part of each chain, rope, or wire is fastened to the rear end (322) of the tool mounting units (327, 328), wherein an end of each chain, rope, or wire is fastened to the mounting bracket (310); and wherein the opposite end of each chain, rope, or wire is also fastened to the mounting bracket (310).

42. The tool unit (300) according to claim 34, wherein the pair of foldable and/or flexible connectors (330,340) are each made from chain, rope, or wire, and wherein the tool mounting units (327, 328) each comprises a guide channel (329) adapted for receiving its own chain, rope, or wire; wherein the guide channel (329) is formed in the front end (321) of the tool mounting unit (327, 328), wherein one part of each chain, rope, or wire is fastened to the rear end (322) of the tool mounting units (327, 328), wherein an end of each chain, rope, or wire is fastened to the mounting bracket (310); wherein the opposite end of each chain, rope, or wire is also fastened to the mounting bracket (310); and wherein the mounting bracket (310) comprises a pair of protruding rods or plates (312, 314), and wherein the opposite end of each chain, rope, or wire is fastened to its own protruding rod or plate (312, 314).
